(19) United States
(12) Patent Application Publication
(10) Pub. No.: US 2010/0221043 A1
(43) Pub. Date: Sep. 2, 2010

(54) SCREEN-CONTROLLED SCOROTRON CHARGING DEVICE

(75) Inventors: Katsuhiko Gotoda, Hsinchu (TW); Chia-Huei Lin, Sijhih City (TW)

Correspondence Address: BACON & THOMAS, PLLC, 625 SLATERS LANE, FOURTH FLOOR, ALEXANDRIA, VA, 22314-1176, US

(73) Assignee: AVISION INC., Hsinchu (TW)

(21) Appl. No.: 12/394,842

(22) Filed: Feb. 27, 2009

(51) Int. Cl. G03G 15/02

(52) U.S. Cl. 399/171

(57) ABSTRACT

A scorotron charging device is disposed in an image forming apparatus and for charging a surface of a photoconductor, which is driven to rotate in a rotational direction. This device includes a discharging electrode and a grid electrode, which are aligned to a longitudinal direction of the photoconductor. The grid electrode is disposed between the discharging electrode and the photoconductor and determines the charging of the surface of the photoconductor. The grid electrode includes a first section, which has a plurality of first apertures and a first opening ratio, and a second section, which has a plurality of second apertures and a second opening ratio. The first opening ratio is greater than the second opening ratio. Aperture areas along any two parallel lines, drawn across the first section and the second section and being substantially transverse to the longitudinal direction, are in equal measure.

### BACKGROUND OF THE INVENTION

1. Field of the Invention

The invention relates in general to a scorotron charging device, and more particularly to a screen-controlled scorotron charging device.

2. Description of the Related Art

For forming an image by an image forming apparatus is usually performed by steps of photoconductor charging, laser beam imaging, toner transferring and developing, fusing, and the like. The available charging technology includes corona charging, roller charging and brush charging. Furthermore, the corona charging technology has the advantage of the high charging uniformity, and is thus frequently applied to the laser image forming apparatus available in general.

The corona charging is to create an electric field within a charging section of the photoconductor, wherein the energy of the electric field is sufficiently high to ionize the ambient gas so that the surface of the photoconductor contacts with the ionized air and is charged with charges. The imaging quality depends on the potential of the surface of the charged photoconductor and the charging uniformity. So, it is an object of the invention to make the surface of the charged photoconductor to reach a predetermined potential level, and to enhance the charging uniformity of the scorotron discharging so that the better imaging quality can be provided, the photoconductor charging can be finished within a shorter period of time, and the higher printing speed can be provided.

### SUMMARY OF THE INVENTION

The invention is directed to a screen-controlled scorotron charging device having a grid electrode divided into at least two sections, and the grid electrode further includes a plurality of first grid wires in a first section and a plurality of second grid wires in a second section, wherein the features of the two sections are different from each other. For example, a distance between any two adjacent first grid wires along the longitudinal direction is longer than a distance between any two adjacent second grid wires along the longitudinal direction, or the first grid wires and the second grid wires are slanted at different angles, so that different charging effects may be generated on a surface of a photoconductor through these two sections of the grid electrode. Consequently, the potential of the surface of the charged photoconductor can be increased, and the better charging uniformity may be provided. Accordingly, the better imaging quality may be provided.

According to a first aspect of the present invention, a scorotron charging device disposed in an image forming apparatus is provided. The scorotron charging device charges a surface of a photoconductor. The photoconductor may be rotated in a rotational direction. The scorotron charging device includes a discharging electrode and a grid electrode. The discharging electrode and the grid electrode are aligned in a longitudinal direction of the photoconductor. The grid electrode is disposed between the discharging electrode and the photoconductor, and determines the maximum potential to which the surface of the photoconductor will be charged. The grid electrode is at least divided into a first section and a second section in this invention. The first section has a plurality of first apertures and a first opening ratio. The second section has a plurality of second apertures and a second opening ratio. The first opening ratio is greater than the second opening ratio. In addition, the aperture areas along any two parallel lines, drawn across the first section and the second section and being substantially transverse to the longitudinal direction, are in equal measure.

The invention will become apparent from the following detailed description of the preferred but non-limiting embodiments. The following description is made with reference to the accompanying drawings.

### BRIEF DESCRIPTION OF THE DRAWINGS

FIG. 1 is a side view showing part of the structure of an image forming apparatus according to one embodiment of the invention;

FIG. 2 is a cross-sectional view showing the scorotron charging device illustrated in FIG. 1;

FIG. 3 is a top view showing a grid electrode according to one embodiment of the invention;

FIG. 4 is a top view showing a grid electrode according to another embodiment of the invention;

FIG. 5A is a top view showing part of the grid electrode of the present invention;

FIG. 5B is a chart showing the surface potential along a line A-A′ of the photoconductor of FIG. 5A;

FIG. 6A is a top view showing part of the grid electrode of a prior art;

FIG. 6B is a chart showing the surface potential along a line B-B′ of the photoconductor of FIG. 6A of the prior art; and

FIGS. 7 and 8 are schematic illustrations respectively showing grid electrodes according to two other embodiments of the invention.

### DETAILED DESCRIPTION OF THE INVENTION

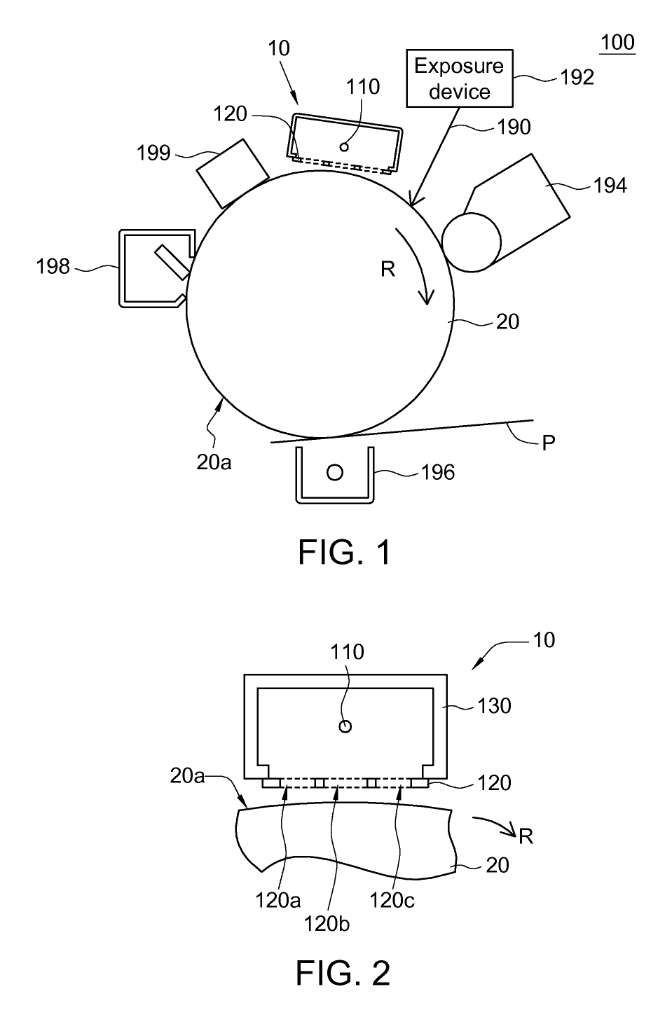

Please refer to FIG. 1 and FIG. 2, the present embodiment provides a scorotron charging device 10. This charging device is disposed in an image forming apparatus 100 and charges a surface 20a of a photoconductor 20. The photoconductor 20 is rotated in a rotational direction R and extending in a longitudinal direction. The scorotron charging device 10 includes a discharging electrode 110 and a grid electrode 120. The discharging electrode 110 is aligned with the photoconductor 20. The grid electrode 120 is disposed between the discharging electrode 110 and the photoconductor 20 and is aligned with the photoconductor 20 and determines the maximum potential to which the surface 20a of the photoconductor 20 will be charged.

The image forming apparatus 100 shown in FIG. 1 includes a photoconductor 20, which is formed in a cylindrical shape and is rotated along a rotational direction R shown in FIG. 1. Around the photoconductor 20, along the rotation direction R, the image forming apparatus 100 includes a scorotron charging device 10, an information light beam 190 emitted from an exposure device 192, a developing device 194, a transfer charging device 196, a cleaning device 198, and a discharging device 199. The scorotron charging device 10 is disposed on a surface 20a of the photoconductor 20 and uniformly charges the surface 20a of the photoconductor 20. The information light beam 190 performs an exposing operation in response to an image information, for example, by means of a laser optical system to form an electrostatic latent image on the photoconductor 20. The developing device 194, for example a developer cartridge, visualizes the electrostatic latent image by applying toner to adhere on the surface 20a of the photoconductor 20 in accordance with the electrostatic latent image, then a latent image is formed on the surface 20a of the photoconductor 20 by the developed toner. The transfer charging device 196 transfers the developed toner from the surface 20a of the photoconductor 20 onto a transferred sheet P such as a paper. The cleaning device 198 cleans residual toner on the photoconductor 20. Then, the discharging device 199 discharges residual electric charge on the surface 20a of the photoconductor 20.

And referring to FIG. 2, showing a cross-sectional view of the scorotron charging device 10, includes a discharging electrode 110, a grid electrode 120 and a housing 130. The discharging electrode 110 is disposed in the housing 130. The discharging electrode 110 and the grid electrode 120 are aligned to a longitudinal direction y of the photoconductor 20. The grid electrode 120 is disposed between the discharging electrode 110 and the photoconductor 20, and determines the maximum potential to which the surface 20a of the photoconductor 20 will be charged.

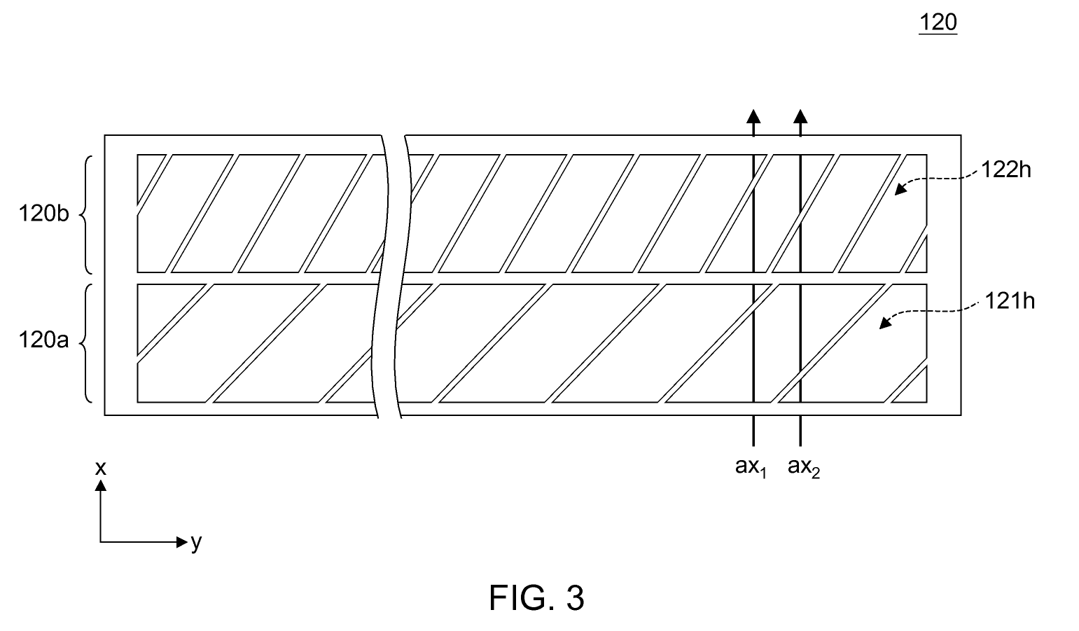

As shown in FIG. 3, in one embodiment of the invention, the grid electrode 120 includes a first section 120a and a second section 120b. In addition, the first section 120a has a plurality of first apertures 121h and a first opening ratio, and the second section 120b has a plurality of second apertures 122h and a second opening ratio. The first opening ratio is greater than the second opening ratio. Because of the greater opening ratio of the first section 120a, a larger amount of discharge current from the discharging electrode 110 is passed to the surface 20a, which makes it possible for the charge carriers captured in the traps of the dielectric layer of the photoconductor 20 to be released in a shorter period of time. By shortening the time for releasing the charge carriers, a longer period of time is left for charging the surface 20a, and consequently, in the first section 120a, the surface 20a is charged to a potential level higher than that using the conventional grid electrode. In addition, the aperture areas along any two parallel lines ax₁ and ax₂, drawn across the first section 120a and the second section 120b and being substantially transverse to the longitudinal direction y, are substantially in equal measure. Consequently, the potential of the surface 20a of the charged photoconductor 20 can reach the predetermined potential for obtaining a high quality image, and the better charging uniformity can be provided. Accordingly, the better imaging quality can be provided.

In the following embodiment, the grid electrode having three sections will be illustrated as an example. However, the grid electrode may also be divided into at least two sections without departing from the scope of the invention.

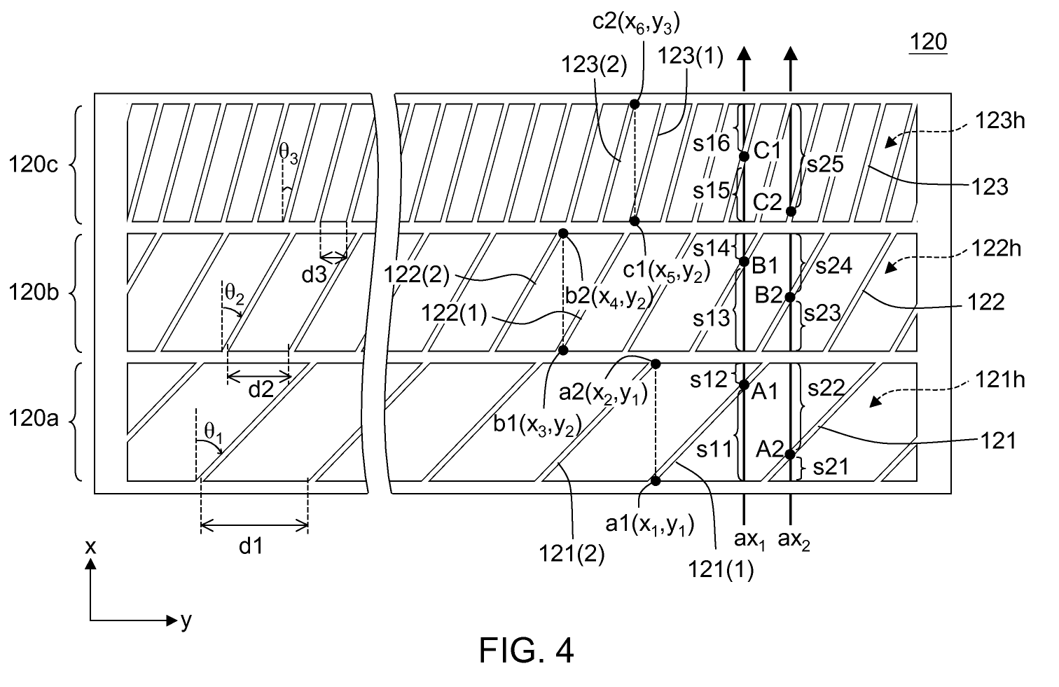

As show in FIG. 4, in this embodiment, the grid electrode 120 is divided into three sections 120a, 120b and 120c, which have different opening ratios. The charging of the surface 20a of the photoconductor 20 is determined through the grid electrode, and different charging effects are obtained according to different opening ratios of the sections. Consequently, the potential of the surface 20a of the charged photoconductor can approximate to the predetermined potential.

The first section 120a is located on an upstream side of the second section 120b with respect to the rotational direction R of the photoconductor 20, and the third section 120c is located on a downstream side of the second section with respect to the rotational direction R of the photoconductor 20. The surface 20a is initially charged in the first section 120a, and then being charged at a higher rate in the second section 120b, and finally, in the third section 120c, the potential of the surface 20a is uniformed and stabilized.

The grid electrode 120 of this embodiment will be described in detail in the following. As shown in FIG. 4, the grid electrode 120 includes a plurality of first grid wires 121, a plurality of second grid wires 122 and a plurality of third grid wires 123, which are respectively disposed in the first section 120a, the second section 120b and the third section 120c. The first grid wires 121 form a plurality of first apertures 121h in the first section 120a such that the first section 120a has a first opening ratio. The second grid wires 122 form a plurality of second apertures 122h in the second section 120b so that the second section 120b has a second opening ratio. The third grid wires 123 form a plurality of third apertures 123h in the third section 120c such that the third section 120c has a third opening ratio.

In this embodiment, because the third section 120c does not effectively influence the resulting potential of the surface 20a of the photoconductor 20, the third opening ratio may be designed to be equal to or smaller than the second opening ratio of the second section 120b. Although the third opening ratio is smaller than the second opening ratio in this illustrated embodiment, the invention is not limited thereto.

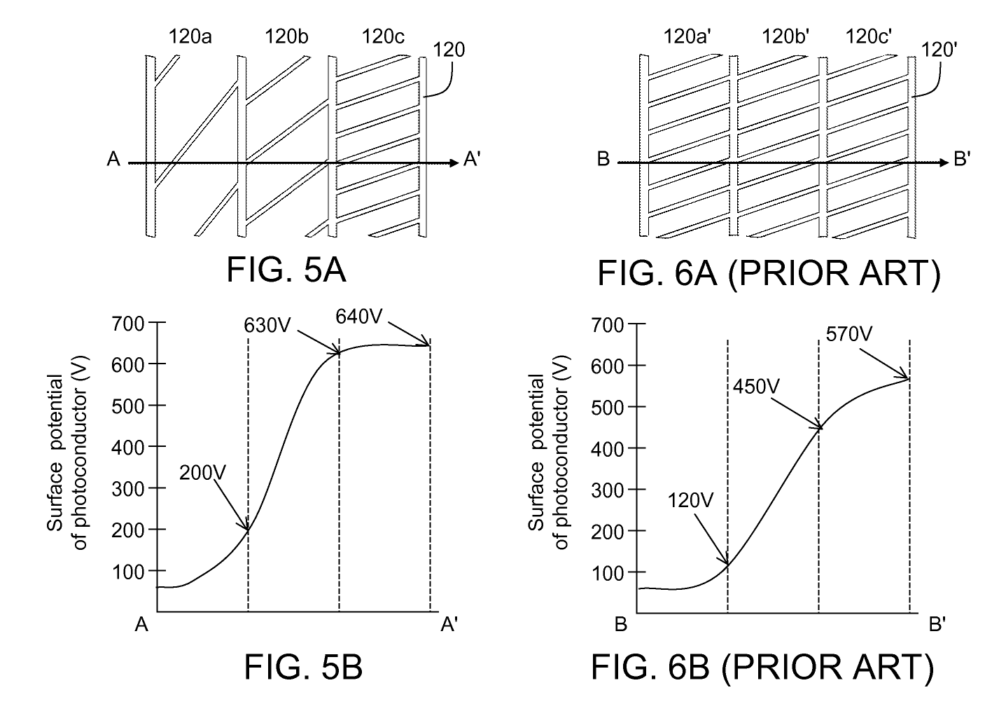

In order to make a person skilled in the art easily understand the charging effect provided in this embodiment, in which the grid electrode 120 is divided into three sections, FIGS. 5A and 5B are provided to illustrate the charging potential variation of the surface 20a of the photoconductor 20 through the sections 120a, 120b and 120c of the present embodiment, and FIGS. 6A and 6B provided to illustrate the charging potential variation of the surface 20a of the photoconductor 20 through the sections 120a′, 120b′ and 120c′ of the grid electrode 120′ of the prior art. However, the person skilled in the art may easily understand that the data in the present embodiment and the data in the prior art are provided for the illustrative and non-restrictive purposes.

Please refer to FIGS. 5A, 5B, 6A and 6B. FIG. 5A is a top view showing part of the grid electrode in the present embodiment. FIG. 5B is a chart showing potential change of the surface 20a when moving past the grid electrode 120 of FIG. 5A from Point A to Point A′. FIG. 6A is a top view showing part of the grid electrode of the prior art. FIG. 6B is a chart showing potential change of the surface 20a when moving past the grid electrode 120′ of FIG. 6A from Point B to Point B′. In addition, potential of the surface 20a from Point A to Point A′ and Point B to Point B′ of the drawings are measured in the present embodiment and the prior art, respectively. As can be understood from FIG. 5B, the potential of the surface 20a of the photoconductor 20 reaches 200V as the surface 20a enters the second section 120b of the grid electrode 120 of this embodiment. In comparison, in the prior art illustrated in FIG. 6B, the potential of the surface 20a of the photoconductor 20 only reaches 120V as the surface 20a enters the second section 120b′. In addition, as the surface 20a enters the third section 120c in this embodiment, the potential of the surface 20a reaches 630V, which is close to the predetermined voltage of 640V for forming a high quality image. Contrarily, in the prior art the potential of the surface 20a obtained is much lower than the predetermined voltage.

Consequently, using the structure of the grid electrode 120 of this embodiment may have the advantages of obtaining the potential approximating to the predetermined potential and can obtain the good charging uniformity.

In the present embodiment, one end of each grid wire in a section is aligned with an end of a neighboring grid wire in the same section. That is, the aligned two ends have the same y-coordinate. For example, please refer to FIG. 4 again, a first axis ax₁ and a second axis ax₂ extend across the first section 120a, the second section 120b and the third section 120c, and at right angles to the longitudinal direction of the grid electrode 120. An end a1(x₁,y₁) of the grid wire 121(1) is aligned with an end a2(x₂,y₁) of the grid wire 121(2) in the first section 120a, an end b1(x₃,y₂) of the grid wire 122(1) is aligned with an end b2(x₄,y₂) of the grid wire 122(2) in the second section 120b, and an end c1(x₅,y₃) of the grid wire 123(1) is aligned with an end b1(x₆,y₃) of the grid wire 123(2) in the third section 120c, so that the number of the intersection points by the first axis ax₁ and one of the first grid wires, one of the second grid wires and one of the third grid wires is the same with the number of the intersection points by the first axis ax₂ and one of the first grid wires, one of the second grid wires and one of the third grid wires.

For example, refer to FIG. 4, the first axis ax₁ intersects with at least one of the first grid wires 121, at least one of the second grid wires 122 and at least one of the third grid wires 123 respectively at intersection points A1, B1 and C1, the second axis ax₂ intersects with at least one of the first grid wires 121, at least one of the second grid wires 122 and at least one of the third grid wires 123 respectively at intersection points A2, B2 and C2.

Consequently, by the first axis ax1 and the second axis ax2, the sum of the measure of aperture areas s11 and s12 is equal to the sum of the measure of aperture areas s21 and s22, the sum of the measure of aperture areas s13 and s14 is equal to the sum of the measure of aperture areas s23 and s24, and the sum of the measure of aperture areas s15 and s16 is equal to the measure of aperture areas s25. Therefore, the sum of the measure of aperture areas s11, s12, s13, s14, s15 and s16 is equal to the sum of the measure of aperture areas s21, s22, s23, s24 and s25.

In addition, as shown in FIG. 4, in the structure of the grid electrode 120 of this embodiment, the distance d1 between any two adjacent first grid wires 121 along the longitudinal direction y is longer than the distance d2 between the any two adjacent second grid wires 122 along the longitudinal direction y, and an angle θ₁ at which the first grid wire 121 is slanted and is greater than an angle θ₂ at which the second grid wire 122 is slanted. Furthermore, a distance d3 between any two adjacent third grid wires 123 along the longitudinal direction y is shorter than the distance d2 between any two adjacent second grid wires 122 along the longitudinal direction y. The angle θ₂ at which the second grid wire 122 is slanted and is greater than an angle θ₃ at which the third grid wire 123 is slanted.

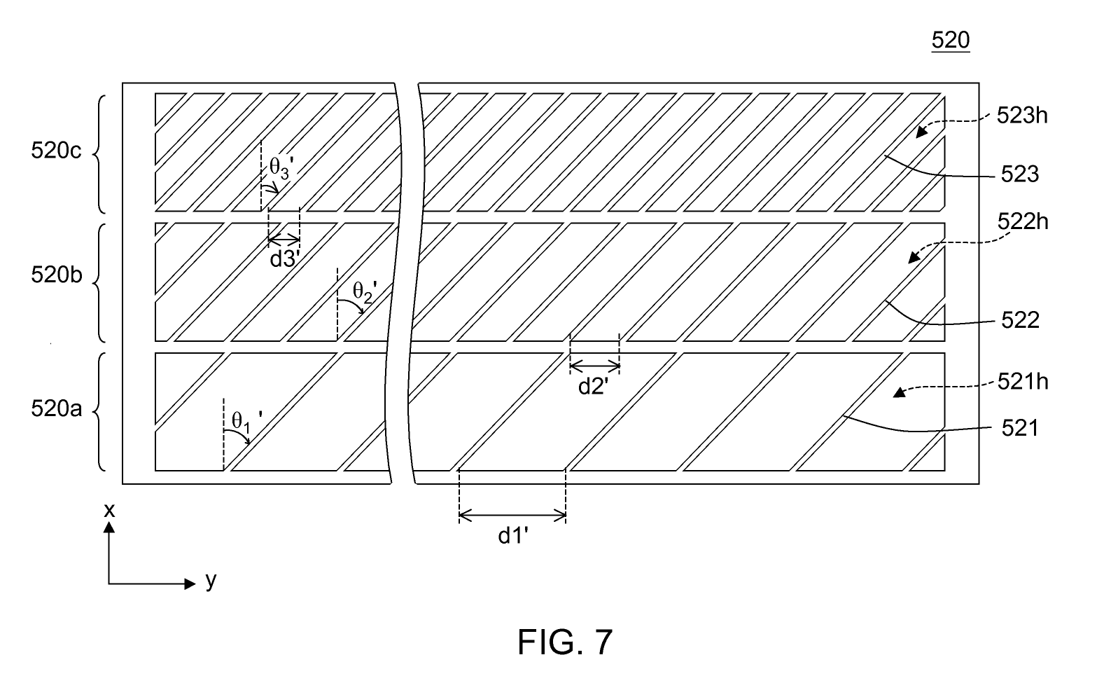

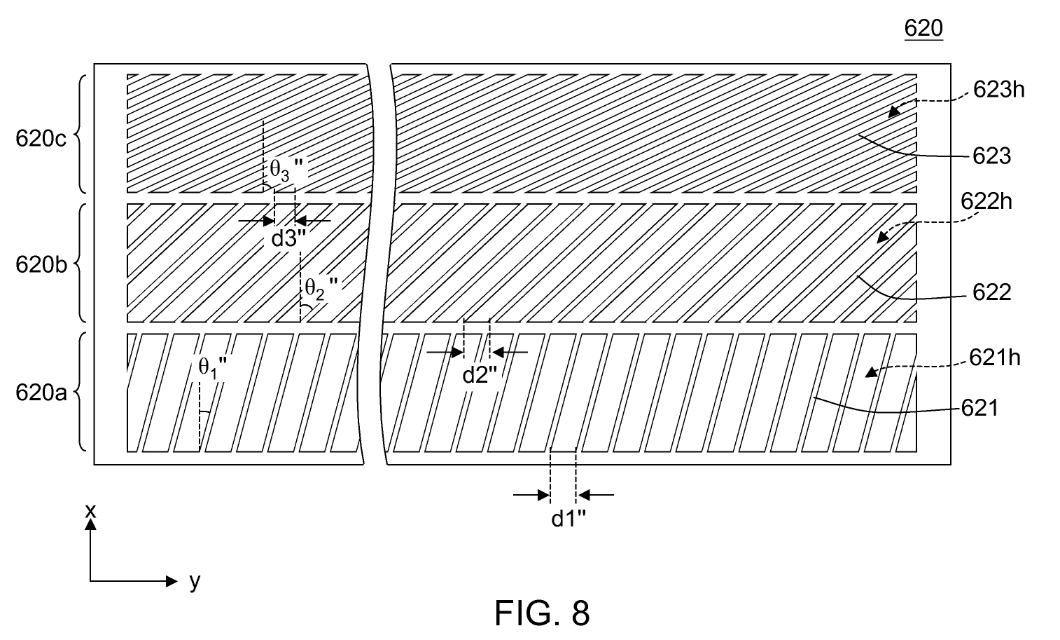

In addition, FIGS. 7 and 8 are schematic illustrations respectively showing grid electrodes according to two other embodiments of the invention. In FIG. 7, a grid electrode 520 divides into a first section 520a, a second section 520b and a third section 520c, and the three sections respectively have first grid wires 521, second grid wires 522 and third grid wires 523. The first grid wires 521 form a plurality of first apertures 521h in the first section 520a such that the first section 520a has a first opening ratio, the second grid wires 522 form plurality of second apertures 522h in the second section 520b such that the second section 520b has a second opening ratio, and the third grid wires 523 form a plurality of third apertures 523h in the third section 520c such that the third section 520c has a third opening ratio. The first grid wires 521 of the first section 520a, the second grid wires 522 of the second section 520b and the third grid wires 523 of the third section 520c are slanted at equal angles θ₁′, θ₂′ and θ₃′, respectively, and a distance d1′ between any two adjacent first grid wires 521 along the longitudinal direction y is longer than a distance d2′ between any two adjacent second grid wires 522 along the longitudinal direction y, so that the opening ratio of a first section 520a is greater than the opening ratio of a second section 520b. Correspondingly, the distance d2′ between any two adjacent second grid wires 522 along the longitudinal direction y is longer than a distance d3′ between any two adjacent third wires 523 along the longitudinal direction y so that the opening ratio of the second section 520b is greater then the opening ratio of a third section 520c.

In FIG. 8, a grid electrode 620 divides into a first section 620a, a second section 620b and a third section 620c, and the three sections respectively have first grid wires 621, second grid wires 622 and third grid wires 623. The first grid wires 621 form a plurality of first apertures 621h in the first section 620a such that the first section 620a has a first opening ratio, the second grid wires 622 form a plurality of second apertures 622h in the second section 620b such that the second section 620b has a second opening ratio, and the third grid wires 623 form a plurality of third apertures 623h in the third section 620c such that the third section 620c has a third opening ratio. Distances d1″ between any two adjacent first grid wires along the longitudinal direction y, d2″ between any two adjacent second grid wires along the longitudinal direction y and d3″ between any two adjacent third grid wires along the longitudinal direction y are substantially equal, and the first grid wires 621, the second grid wires 622 and the third grid wires 623 of the grid electrode 620 are respectively slanted at angles θ₁″, θ₂″ and θ₃″, the angle θ₂″ is greater than the angle θ₁″, the angle θ₃″ is greater than the angle θ₂″ so that the opening ratio of the first section 620a is greater than the opening ratio of the second section 620b, and the opening ratio of the second section 620b is greater than the opening ratio of the third section 620c.

In addition, preferably but non-restrictively, the widths of the first section, the second section and the third section in the x-axis direction are substantially equal in this embodiment of the invention.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scorotron charging device in an image forming apparatus for charging a surface of a photoconductor which is driven to rotate in a rotational direction and extending in a longitudinal direction, the scorotron charging device comprising:
a discharging electrode aligned with the photoconductor; and
a grid electrode, disposed between the discharging electrode and the photoconductor and aligned with the photoconductor, for determining the charging of the surface of the photoconductor, the grid electrode comprising:
a first section having a plurality of first apertures and a first opening ratio; and
a second section having a plurality of second apertures and a second opening ratio,
wherein the first opening ratio is greater than the second opening ratio;
wherein aperture areas along any two parallel lines, drawn across the first section and the second section and being substantially transverse to the longitudinal direction, are substantially in equal measure.

2. The scorotron charging device according to claim 1, wherein the first section is located on an upstream side of the second section with respect to the rotational direction of the photoconductor.

3. The scorotron charging device according to claim 1, wherein the grid electrode further comprises a plurality of first grid wires in the first section and a plurality of second grid wires in the second section, wherein the plurality of the first grid wires form the plurality of the first apertures and the plurality of the second grid wires form the plurality of the second apertures.

4. The scorotron charging device according to claim 3, wherein a distance between any two adjacent first grid wires along the longitudinal direction is longer than a distance between any two adjacent second grid wires along the longitudinal direction.

5. The scorotron charging device according to claim 3, wherein the plurality of the first grid wires and the plurality of the second grid wires are slanted at different angles.

6. The scorotron charging device according to claim 5, wherein the plurality of the first grid wires are slanted at a first angle, which is greater than a second angle at which the plurality of the second grid wires are slanted.

7. The scorotron charging device according to claim 3, wherein the grid electrode further comprises:
a third section having a plurality of third apertures and a third opening ratio.

8. The scorotron charging device according to claim 7, wherein the third section is located on a downstream side of the second section with respect to the rotational direction of the photoconductor.

9. The scorotron charging device according to claim 7, wherein the grid electrode further comprises a plurality of third grid wires in the third section, wherein the plurality of the third grid wires form the plurality of the third apertures.

10. The scorotron charging device according to claim 9, wherein a distance between any two adjacent third grid wires along the longitudinal direction is shorter than a distance between any two adjacent second grid wires along the longitudinal direction, and the second opening ratio is greater than the third opening ratio.

11. The scorotron charging device according to claim 9, wherein a distance between any two adjacent third grid wires along the longitudinal direction is equal to a distance between any two adjacent second grid wires along the longitudinal direction.

12. The scorotron charging device according to claim 9, wherein the plurality of the third grid wires are slanted.

13. The scorotron charging device according to claim 1, wherein the grid electrode further comprises:
a third section having a plurality of third apertures and a third opening ratio, wherein the second opening ratio is greater than the third opening ratio.

14. The scorotron charging device according to claim 13, wherein the third section is located on a downstream side of the second section with respect to the rotational direction of the photoconductor.

15. The scorotron charging device according to claim 13, wherein, widths of the first section, the second section and the third section in a direction transverse to the longitudinal direction are substantially equal.
